(19) United States
(12) Patent Application Publication
(10) Pub. No.: US 2026/0087281 A1
(43) Pub. Date: Mar. 26, 2026

(54) PRODUCT SCANNER BASED RADAR SYSTEMS

(71) Applicant: Zebra Technologies Corporation, Lincolnshire, IL (US)

(72) Inventors: Darran Michael Handshaw, Sound Beach, NY (US); Joseph S. Slowik, Nesconset, NY (US); Edward Barkan, Miller Place, NY (US); Robert W. DiGiovanna, Shirley, NY (US)

(21) Appl. No.: 18/894,316

(22) Filed: Sep. 24, 2024

(51) Int. Cl. G06K 7/10; G01S 13/58; G01S 13/89; G06K 7/14

(52) U.S. Cl. CPC G06K 7/10316; G01S 13/581; G01S 13/89; G06K 7/10207; G06K 7/1482

(57) ABSTRACT

Product scanner based radar systems are provided herein. An example product scanner includes a housing, an indicia scanner, and a radar system further comprising a radar chip and an antenna. In the example, the indicia scanner is configured to capture indicia data from a product indicia disposed within an indicia scan region defined by an optical field-of-view of the optical sensor. In the example, the radar system is configured to capture first three-dimensional layer data representative of an exterior feature of a product disposed within a radar field-of-view. In the example, the radar system is configured to capture second three-dimensional layer data representative of an interior feature of the product disposed within the radar field-of-view.

### BACKGROUND

Radar systems use radio waves to detect and locate objects in their surrounding environment. Radar systems function by emitting pulses of electromagnetic waves from a transmitter, which can travel through the air until they hit an object. One or more surfaces of the object may reflect the electromagnetic waves back toward the radar system, which may pick up the reflected electromagnetic waves using a receiver. By measuring the time it takes for the waves to return to the receiver, the radar system can calculate the distance to the object.

### SUMMARY

Apparatuses and methods for indicia scanner based radar systems are provided herein. In an example embodiment, a product scanner may comprise a housing, an indicia scanner, and/or a radar system. In a variation of this example embodiment, the indicia scanner may comprise a light source, a lens, and an optical sensor. In a variation of this example embodiment, the indicia scanner may be configured to capture indicia data from a product indicia disposed within an indicia scan region defined by an optical field-of-view of the optical sensor. In a variation of this example embodiment, the radar system may comprise a radar chip and/or an antenna. In a variation of this example embodiment, the radar system may be configured to capture three-dimensional layer data from a radar field-of-view.

In a variation of this example embodiment, the radar system may be configured to capture first three-dimensional layer data representative of an exterior feature of a product disposed within a radar field-of-view. In a variation of this example embodiment, the radar system may be configured to capture second three-dimensional layer data representative of an interior feature of the product disposed within the radar field-of-view.

In a variation of this example embodiment, the radar system may comprise a radar-product database comprising radar-product training data. In a variation of this example embodiment, the radar-product training data may associate known three-dimensional layer data with one or more known products. In a variation of this example embodiment, the radar system may comprise a radar-product model. In a variation of this example embodiment, the radar-product model may be configured to compare, at least in part, the first three-dimensional layer data and the second three-dimensional layer data to the radar-product training data. In a variation of this example embodiment, the radar-product model may be configured to determine, to within a decision threshold, whether at least one of the first three-dimensional layer data and/or the second three-dimensional layer data represent a known product.

In a variation of this example embodiment, the radar system may comprise a product model comprising one or more of the radar-product model and image data.

In a variation of this example embodiment, the radar system may be configured to generate electromagnetic waves based on radar parameters. In a variation of this example embodiment, the radar system may be configured to transmit the electromagnetic waves. In a variation of this example embodiment, the electromagnetic waves may define the radar field-of-view based, at least in part, on the radar parameters.

In a variation of this example embodiment, the radar system may be configured to receive a first reflection of the electromagnetic waves. In a variation of this example embodiment, the first reflection may indicate the first three-dimensional layer data. In a variation of this example embodiment, the radar system may be configured to receive a second reflection of the electromagnetic waves. In a variation of this example embodiment, the second reflection may indicate the second three-dimensional layer data.

In a variation of this example embodiment, the first three-dimensional layer data and/or the second three-dimensional layer data may comprise doppler shift data indicating a velocity vector associated with one or more reflective surfaces of an object.

In a variation of this example embodiment, the radar field-of-view may comprise a power-on zone, a wake-up zone, and/or a scan zone. In a variation of this example embodiment, the scan region of the radar field-of-view may comprise, at least in part, the indicia scan region defined by the optical field-of-view of the optical sensor.

In a variation of this example embodiment, the radar system may be configured to detect a person within the power-on zone. In a variation of this example embodiment, the radar system may be configured to cause activation of one or more of the indicia scanner or a vision system.

In a variation of this example embodiment, the radar system may be configured to detect an object within the wake-up zone. In a variation of this example embodiment, the radar system may be configured to cause one or more of the indicia scanner and/or a vision system to exit a power-saving mode.

In a variation of this example embodiment, the radar system may be configured to detect an object within the scan region. In a variation of this example embodiment, the radar system may be configured to allow the indicia scanner to capture the indicia data.

In a variation of this example embodiment, the radar system may be configured to detect an object within the scan region. In a variation of this example embodiment, the radar system may be configured to cause a vision system to capture image data.

In a variation of this example embodiment, the product scanner may comprise a vision system comprising a camera, wherein the vision system is configured to capture image data representative of the product.

In another example embodiment, a radar system may comprise a radar chip and/or an antenna. In a variation of this example embodiment, the radar system may be configured to capture first three-dimensional layer data representative of an exterior feature of a product disposed within a radar field-of-view. In a variation of this example embodiment, the radar system may be configured to capture second three-dimensional layer data representative of an interior feature of the product disposed within the radar field-of-view.

In a variation of this example embodiment, the radar system may comprise a radar-product database comprising radar-product training data. In a variation of this example embodiment, the radar-product training data associates known three-dimensional layer data with one or more known products.

In a variation of this example embodiment, the radar-product model may be configured to compare, at least in part, the first three-dimensional layer data and the second three-dimensional layer data to the radar-product training data. In a variation of this example embodiment, the radar-product model may be configured to determine, to within a decision threshold, whether at least one of the first three-dimensional layer data and/or the second three-dimensional layer data represent a known product.

In a variation of this example embodiment, the radar field-of-view comprises one or more of a power-on zone, a wake-up zone, a vision capture region, and a scan region.

In a variation of this example embodiment, the radar system may be configured to detect a person within the power-on zone. In a variation of this example embodiment, the radar system may be configured to generate an activation signal configured to power-on a computing device. In a variation of this example embodiment, the radar system may be configured to transmit the activation signal via a communications interface.

In a variation of this example embodiment, the radar system may be configured to generate electromagnetic waves based on radar parameters. In a variation of this example embodiment, the radar system may be configured to transmit the electromagnetic waves, wherein the electromagnetic waves define the radar field-of-view based, at least in part, on the radar parameters.

In a variation of this example embodiment, the radar system may be configured to receive a first reflection of the electromagnetic waves. In a variation of this example embodiment, the first reflection indicates the first three-dimensional layer data. In a variation of this example embodiment, the radar system may be configured to receive a second reflection of the electromagnetic waves. In a variation of this example embodiment, the second reflection indicates the second three-dimensional layer data.

In a variation of this example embodiment, the first three-dimensional layer data and/or the second three-dimensional layer data may comprise doppler shift data indicating a velocity vector associated with one or more reflective surfaces of an object.

In another example embodiment, a computer-implemented method may comprise capturing three-dimensional layer data from a radar field-of-view. In a variation of this example embodiment, the computer-implemented method may comprise comparing, at least in part, the three-dimensional layer data from the radar field-of-view to radar-product training data. In a variation of this example embodiment, the computer-implemented method may comprise determining, to within a decision threshold, whether the three-dimensional layer data represents a known product.

In a variation of this example embodiment, the computer-implemented method may comprise capturing first three-dimensional layer data representative of an exterior feature of a product disposed within a radar field-of-view. In a variation of this example embodiment, the computer-implemented method may comprise capturing second three-dimensional layer data representative of an interior feature of the product disposed within the radar field-of-view. In a variation of this example embodiment, the computer-implemented method may comprise comparing, at least in part, the first three-dimensional layer data and the second three-dimensional layer data to radar-product training data. In a variation of this example embodiment, the computer-implemented method may comprise determining, to within a decision threshold, whether at least one of the first three-dimensional layer data or the second three-dimensional layer data represent a known product.

In a variation of this example embodiment, the computer-implemented method may comprise detecting a person within a power-on zone; generating an activation signal configured to power-on a computing device; and/or transmitting the activation signal via a communications interface.

In a variation of this example embodiment, the computer-implemented method may comprise generating electromagnetic waves based on radar parameters. In a variation of this example embodiment, the computer-implemented method may comprise transmitting the electromagnetic waves. In a variation of this example embodiment, the electromagnetic waves define the radar field-of-view based, at least in part, on the radar parameters.

In a variation of this example embodiment, the computer-implemented method may comprise receiving a first reflection of the electromagnetic waves. In a variation of this example embodiment, the first reflection indicates the first three-dimensional layer data. In a variation of this example embodiment, the computer-implemented method may comprise receiving a second reflection of the electromagnetic waves. In a variation of this example embodiment, the second reflection indicates the second three-dimensional layer data.

In a variation of this example embodiment, the first three-dimensional layer data and the second three-dimensional layer data each further comprise doppler shift data indicating a velocity vector associated with one or more reflective surfaces of an object.

In a variation of this example embodiment, the radar field-of-view comprises one or more of a power-on zone, a wake-up zone, a vision capture region, and a scan region. In a variation of this example embodiment, the scan region of the radar field-of-view comprises, at least in part, the indicia scan region defined by the optical field-of-view of the optical sensor.

In a variation of this example embodiment, the computer-implemented method may comprise detecting a person within the power-on zone. In a variation of this example embodiment, the computer-implemented method may comprise causing activation of one or more of the indicia scanner or a vision system.

In a variation of this example embodiment, the computer-implemented method may comprise detecting an object within the wake-up zone. In a variation of this example embodiment, the computer-implemented method may comprise causing one or more of the indicia scanner or a vision system to exit a power-saving mode.

In a variation of this example embodiment, the computer-implemented method may comprise detecting an object within the scan region. In a variation of this example embodiment, the computer-implemented method may comprise allowing the indicia scanner to capture the indicia data.

In a variation of this example embodiment, the computer-implemented method may comprise detecting an object within the scan region. In a variation of this example embodiment, the computer-implemented method may comprise causing a vision system to capture image data.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates a block diagram of an example scanner system, according to example embodiments of the present disclosure.

FIG. 2A illustrates a top-down view of an example scanner system and a radar field-of-view, according to example embodiments of the present disclosure.

FIG. 2B illustrates a perspective view of an example scanner system and a radar field-of-view, according to example embodiments of the present disclosure.

FIG. 3 illustrates a side view of an example scanner system and at least one radar field-of-view, according to example embodiments of the present disclosure.

FIG. 4 illustrates an example flowchart for detecting product data using an example scanner system, according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Systems and methods are provided herein for operating a product scanner with radar system functionality. Self-checkouts have become a popular and convenient way for customers to quickly complete their purchases at their own pace while freeing up staff members to perform other retail tasks, such as restocking inventory. Many customers have come to enjoy the autonomy, flexibility, and more efficient transaction turnover provided by self-checkout as opposed to traditional cashier based checkout experiences. Retailers (e.g., supermarkets, department stores, etc.) can also reap many benefits by implementing self-checkout lanes, which can allow retailers to meet customers'expectations during periods of extended labor shortages. For example, a single employee may be able to effectively manage multiple (e.g., 5, 10, 15, etc.) self-checkout stations, while that same employee would otherwise only be able to operate a single manual point-of-sale device as a cashier.

Traditional self-checkouts are equipped with a barcode scanner to allow the customer to scan their own products without the assistance (and/or supervision) of a store employee. As the customer scans each product, a point-of-sale device can capture the product information (e.g., price, item description, etc.) and track the costs associated with the customer's transaction. In some instances, an employee may be supervising multiple customers across various self-checkout stations which can make preventing accidental errors (e.g., missed scans, double scans, etc.) and/or intentional forms of shoplifting (e.g., bagging unscanned items, ticket switching, etc.) difficult. Some traditional self-checkout areas may utilize security cameras to monitor customers in an attempt to dissuade shoplifting activity. However, traditional security cameras may provide limited protection as the cameras may not always identify unscanned items (e.g., behind other items, hidden inside packages, left in the bottom of a cart, etc.). Additionally, or alternatively, traditional security camera systems cannot communicate with the point-of-sale device and, as a result, a customer may appear to scan a high-priced item when in fact they switched the price tag (e.g., barcode, etc.) from the high-priced item with a cheaper price tag from another item, a form of shoplifting known as ticket switching. Some traditional self-checkout stations may be equipped with a scale to weigh items, however, using a scale to check every item may not be practical or desirable and would greatly hinder the benefits (e.g., convenience, speed, efficiency, etc.) associated with self-checkouts. Additionally, or alternatively, scales can easily be tampered with to alter weight measurements, for example, by slightly lifting up or pressing down on an item with a finger during weighing.

In contrast to the traditional systems and techniques described above, improved product scanner systems implementing radar system techniques are described herein. The present disclosure sets forth systems, methods, and apparatuses that, among other things, provide improved methods for scanning the exterior and/or interior of products and/or product packages to detect irregularities (e.g., at self-checkout stations, etc.). Systems, methods, and apparatuses of the present disclosure seek to solve problems associated with traditional self-checkouts stations, such as ticket switching, hiding products inside of larger packages, and/or the like as describe herein. For example, scanner systems (as described herein) may utilize vision systems and/or radar systems to look at (and/or scan) multiple sides of a product to determine if the product matches the associated barcode that was scanned for the product. It should be appreciated that, in such examples, various forms of ticket switching, such as hiding more expensive items behind lower cost items, may be prevented by using vision cameras and/or radar systems to identify the physical item being scanned in addition to (and/or independent of) the price tag (or barcode). Another advantage unique to using radar systems to scan products is that radar waves may be configured to scan through a products packaging (e.g., cardboard box, etc.) to detect any additional items hidden inside of the packaging which may go unseen by employees, cameras, and/or other security systems. Those of skill in the art will recognize that low-power radar systems may also function as a wake-up sensor, allowing devices with higher power demands to enter a power saving mode until a customer (and/or product) is detected by the radar system.

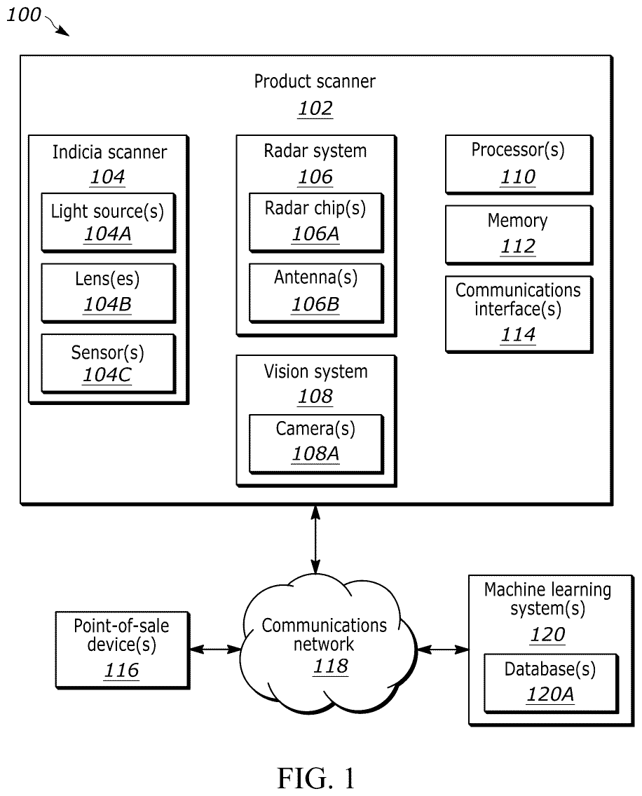

FIG. 1 illustrates a block diagram of an example scanner system, according to example embodiments of the present disclosure. As shown, a scanner system 100 comprises a product scanner 102, point-of-sale device(s) 116, a communications network 118, and machine learning system(s) 120. In some examples, the scanner system 100 may be a self-checkout station (or the like) configured to scan one or more products and identify each product (e.g., using a barcode, visions systems, radar imaging, etc.) to one or more point-of-sale devices that can facilitate the purchase of the product(s).

In the depicted example, the product scanner 102 may be one or more of a handheld product scanner (e.g., an inventory scanner gun, etc.), a fixed product scanner (e.g., an in-counter scanner, biotic scanner, etc.), and/or the like as described herein. As illustrated, the product scanner 102 may be communicatively coupled, via the communications network 118, to one or more of the point-of-sale device(s) 116 and/or the machine learning system(s) 120. The product scanner 102, as shown, comprises an indicia scanner 104, a radar system 106, a vision system 108, processor(s) 110, memory 112, and communication interface(s) 114.

The indicia scanner 104, as shown, may be any optical scanner capable of reading data from a product indicia tag or label (e.g., barcode, Universal Product Code (UPC), Price Look-up Code (PLU), Quick-Response (QR) code, and/or the like). For example, the indicia scanner 104 may be an optical barcode scanner (e.g., Charge-Coupled Device (CCD) readers, etc.) configured to read printed barcodes (and/or the like) using a light source (e.g., laser, Light Emitting Diode (LED), etc.) and transmit data decoded from the barcode (and/or the like) to a computer (e.g., point-of-sale device(s) 116 or any other computing device described herein). As illustrated, the indicia scanner 104 comprises light source(s) 104A, lens(es) 104B, and sensor(s) 104C. The light source(s) 104A may be any light source described herein including, without limitation, one or more of a laser diode, an LED, an infrared bulb, and/or the like. The light source(s) 104A may be configured to direct light onto a product indicia (e.g., barcode) to cause the surface of the product indicia to reflect light back toward a sensor (e.g., sensor(s) 104C) of the indicia scanner. The lens(es) 104B may be any protective lens described herein including, without limitation, one or more of a glass lens, a polyacrylic lens, and/or any other transparent covering. The lens(es) 104B may be configured to allow light to pass from light source(s) 104A to a product indicia and/or allow reflected light to pass from the product indicia to sensor(s) 104C. The lens(es) 104B may be configured to protect (and/or separate) the interior components (e.g., source(s) 104A, lens(es) 104B, sensor(s) 104C, electrical connections, circuit boards, etc.) of the indicia scanner 104 from the hazards of the exterior environment (e.g., dirt, dust, impacts, etc.). The sensor(s) 104C may be any optical sensor described herein including, without limitation, one or more of a photodiode, a Charge-Coupled Device (CCD) sensor, a Complementary Metal-Oxide-Semiconductors (CMOS) sensor, a laser diode, and/or any other sensor for decoding a product indicia. The sensor(s) 104C may be configured to decode information (or data), for example, from light reflected off of the product indicia (e.g., QR code, etc.).

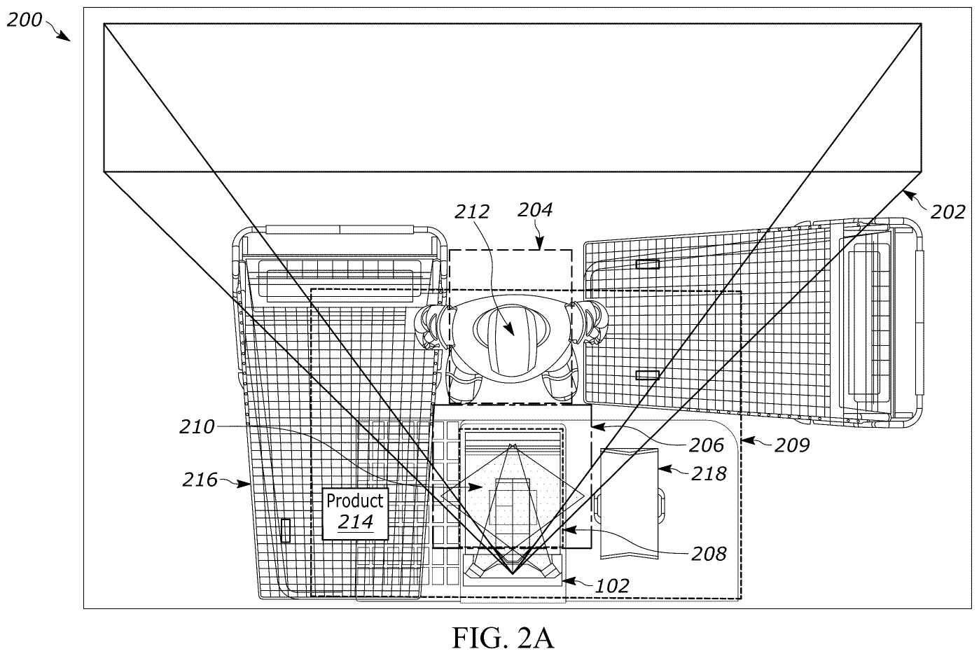

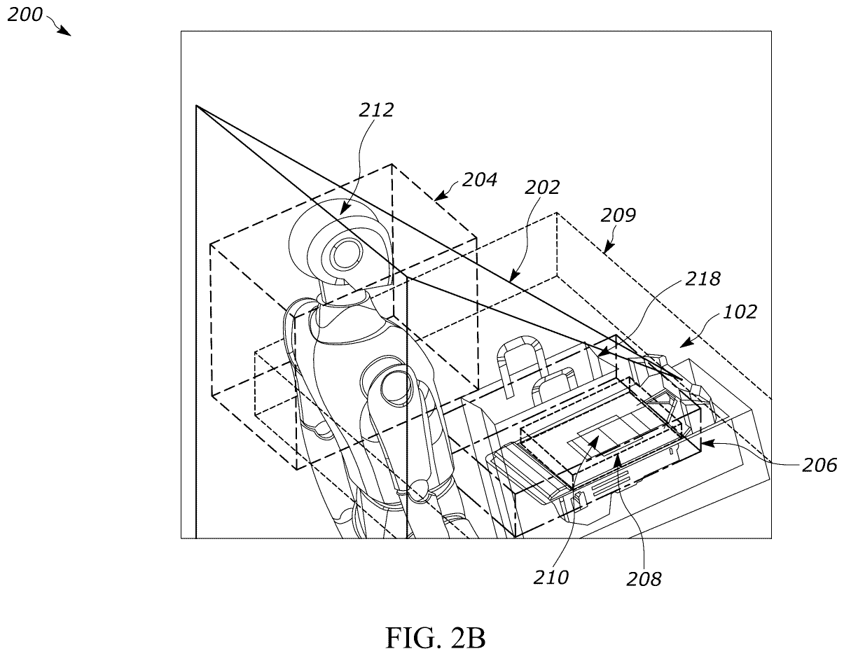

The radar system 106, as shown, may be any radio detection and/or ranging circuitry capable of detecting and/or locating objects using radio waves. For example, the radar system 106 may be a millimeter wave (mmWave) radar package (e.g., chip, antenna, etc.) configured to emit (or chirp) radio waves (e.g., electromagnetic waves, etc.) and analyze any returning waves (e.g., reflections, echoes, etc.). As illustrated, the radar system 106 comprises radar chip(s) 106A and antenna(s) 106B. The radar chip(s) 106A may be any radar circuitry (e.g., Printed Circuit Board (PCB), System on a Chip (SoC), etc.) for generating and/or receiving electromagnetic waves (e.g., mmWave, etc.). In some examples, the radar chip(s) 106A may be disposed in the head of a product scanner (e.g., a handheld product scanner). In some other examples, the radar chip(s) 106A may be disposed in a fixed product scanner (e.g., an in-counter scanner, biotic scanner, etc.). The antenna(s) 106B may be configured to amplify and/or emit any or all electromagnetic waves generated from the radar chip(s) 106A. The antenna(s) 106B may be configured to receive and/or capture any or all electromagnetic waves reflected (or echoed) from the surface of an object. In some examples, the antenna(s) 106B may comprise (or define) a field-of-view for the radar system 106 (e.g., radar field-of-view 202 as will be described in further detail below in connection with at least FIG. 2A). For example, the antenna(s) 106B may be configured to produce (or define) an 80×80 degree (or any other number) field-of-view. In some other examples, the field-of-view may be adjusted by configuring (or reconfiguring) the physical layout of the antenna(s) 106B (e.g., by adding additional surface area to the antenna(s) 106B, by adjusting the position of the antenna(s) 106B, etc.).

In some examples, the field-of-view may be adjusted by changing the settings or parameters associated with the radar chip(s) 106A (e.g., by adjusting the chirp parameters, etc.). For example, using software controls the chirp parameters of the radar chip(s) 106A may be adjusted to increase (and/or decrease) the strength of radio waves (e.g., electromagnetic waves ranging from 30-300 GHz, etc.), the distance (and/or direction) of travel of radio waves, and/or the like as described herein. Examples of chirp parameters (or radar parameters) may comprise one or more of a range, velocity, chirp time (e.g., in μs or any other unit of time), radio frequency duty cycle, active chirping time, max beat frequency, carrier frequency, range resolution, velocity resolution, chirp repetition period, compliance chirp time, radar cube size, valid sweep bandwidth, end frequency, and/or the like as described herein. In some examples, a field-of-view of the radar system 106 may be adjusted by physically relocating (or moving) the radar chip(s) 106A and/or the antenna(s) 106B. For example, the radar chip(s) 106A and/or the antenna(s) 106B may be mechanically coupled (e.g., using fasteners, adhesive, etc.) to a radar platform that may swivel, rotate, tilt, translate, and/or the like (e.g., using a servomotor, stepper motor, etc.). In some examples, the radar system 106 may actively change its resolution, angle, and/or the like as required for different applications (i.e., to function as a wake-up system, to dimension items, to track item movement, etc.) by adjusting the radar parameters as described herein.

In some examples, the radar field-of-view of the radar system 106 may be configured to overlap, at least in part, with a field-of-view of the indicia scanner 104 and/or a field-of-view of the vision system 108. In some such examples, the radar field-of-view of the radar system 106 may extend beyond one or more overlapping fields-of-view. In some such examples, the radar field-of-view of the radar system 106 may penetrate (and/or see through) at least some packaging materials (e.g., cardboard, plastics, glass, etc.). It should be appreciated that the radar chip(s) 106A and/or the antenna(s) 106B may be disposed (or placed) within the product scanner 102 (or the like as desired herein) in locations where traditional imaging based field-of-view reflections are a problem and/or are not possible due to a lack of a transparent window. For example, traditional imaging based field-of-view reflections may cause eyesight problems (e.g., injury, blurred vision, etc.) if they are directed toward a human face or eyes. In contrast, the radar field-of-view of the radar system 106 may be directed toward a human face (e.g., as shown in FIGS. 2A and 2B and described in further detail below) without interfering with a person's vision. In some examples, the radar system 106 may perform a full scan of the field-of-view at (or near) a typical imager (e.g., camera sensor, thermal imager, etc.) framerate (e.g., 24 Frames Per Second (FPS), 60 FPS, or any other number). Additionally, or alternatively, use of the doppler effect may facilitate minute vibrations and/or movements to be detected by the radar system 106. Additionally, or alternatively, even though the radar system 106 may see through thin (e.g., equal to, or less than, 2 mm thickness or any other number) cardboard and/or plastic, the radar system 106 may detect those elements of a product package by receiving (or picking up) at least a portion of the radio wave(s) reflected (or echoed) off of those elements of the product package. For example, the radar system 106 may see through a layer of cardboard while indicating that the layer of cardboard is present. In some examples, to detect and/or prevent ticket switching, the radar system 106 may be configured to detect an item hidden in a box (or other package) that is not supposed to be there. In addition, the radar system 106 may dimension interior and/or exterior of items to ensure they match a product indicia that is scanned for the item.

The vision system 108, as shown, may be any computer vision system configured to capture and/or interpret images and/or video content. For example, the vision system 108 may be a computer vision system for recording images of a product during checkout, comparing those images of the product to a machine learning database (e.g., training data, database(s) 120A, etc.), and/or identifying the product in the recorded images. In some examples, the vision system 108 may leverage the indicia scanner 104 and/or the point-of-sale device(s) 116 to determine whether the product in the recorded images matches a product associated with a product indicia (e.g., barcode, price tag, etc.). As illustrated, the indicia scanner 104 comprises the camera(s) 108A. The camera(s) 108A may be any camera, imager, image sensor, and/or the like as described herein for recording still images and/or video content. In some examples, the camera(s) 108A may comprise (or define) one or more camera fields-of-view. In some examples, the vision system 108 may comprise a machine learning algorithm for detecting, identifying, and/or tracking objects in recorded images and/or video. In some such examples, the machine learning algorithm (e.g., object detection algorithm, etc.) may leverage processor(s) 110 and/or computer program instructions stored on memory 112 to perform one or more operations described herein in connection with the vision system 108.

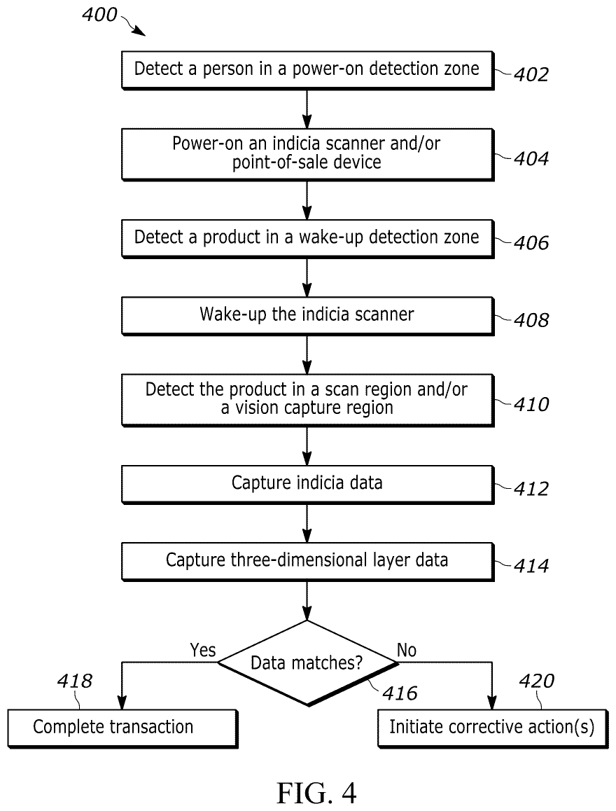

The processor(s) 110, as shown, may be any processor or Central Processing Unit (CPU) of a computing device. The processor(s) 110 may comprise a plurality of processors and/or one or more processors having multiple cores. In some examples, the processor(s) 110 may comprise one or more cores of different types, such as an application processor unit, Graphic Processing Unit (GPU), and/or the like. In some examples, the processor(s) 110 may comprise one or more of a microcontroller, a microprocessor, a digital signal processor, and/or any other processing units described herein. Alternatively, or additionally, the functionality described herein (e.g., in connection with the process 400 as illustrated in FIG. 4) may be performed, at least in part, by one or more hardware logic components associated with the processor(s) 110. For example, and without limitation, illustrative types of hardware logic components associated with the processor(s) 110 that may be used to perform the operations described herein may include Field-Programmable Gate Arrays (FPGAs), Application-Specific Integrated Circuits (ASICs), Application-Specific Standard Products (ASSPs), System on a Chip (SoC), Complex Programmable Logic Devices (CPLDs), and/or the like. In some examples, the processor(s) 110 may comprise on-board (or local) memory, which also may store at least one set of program code, program instructions, firmware, software, an Operating System (OS), and/or the like.

The memory 112, as shown, may be any volatile memory, non-volatile memory, removable media device, non-removable media device, tangible machine-readable medium, non-transitory machine-readable medium, and/or machine-readable storage device for storage of electronic data (e.g., computer-readable software instructions, data structures, program code, firmware, software, and/or any other data described herein). The memory 112 may comprise Random Access Memory (RAM), Read-Only Memory (ROM), Electrically Erasable Programmable Read-Only Memory (EEPROM), flash memory, a Compact Disc (CD), a Digital Versatile Disk (DVD), magnetic disk storage, and/or any other electronic storage device which can be used to store electronic data. The memory 112 may be implemented as Computer-Readable Storage Media (CRSM), which may comprise any available physical media accessible by the processor(s) 110 to execute instructions stored on the memory. In some examples, a CRSM may include RAM and/or flash memory (e.g., NAND flash memory, NOR flash memory, etc.). The memory 112 may be any example of non-transitory computer-readable storage media. The memory 112 may store at least one set of program code, program instructions, firmware, software, an Operating System (OS), and/or any other data to implement the functionality and/or operations described herein (e.g., in connection with the process 400 as illustrated in FIG. 4) for various example systems. In some examples, the memory 112 may store one or more radar parameters for controlling the radar system 106 as described herein.

In the depicted example, the communication interface(s) 114 may be any communications hardware, software, and/or protocols that allow a computing device (e.g., the product scanner 102) to communicate with another computing device (e.g., via the communications network 118). For example, the communication interface(s) 114 may facilitate communication between the product scanner 102 and point-of-sale device(s) 116 and/or machine learning system(s) 120. In some examples, the communication interface(s) 114 comprise a Wi-Fi circuit (e.g., Dual-band, Tri-band, dual-antenna, etc.), ZigBee circuit, Bluetooth circuit (e.g., Bluetooth 5.2, Bluetooth Low Energy (BLE), etc.), LTE circuit, and/or any other communications protocol, hardware, software, and/or firmware. The communication interface(s) 114 permit communication with remote device(s), such as mobile devices (e.g., smart phones, mobile scanners, etc.), systems (e.g., cloud services, remote servers, etc.), and/or the like. The communication interface(s) 114 may leverage any type of communications network (e.g., communications network 118), including data and/or voice network, and may be implemented using wired infrastructure (e.g., cable, CAT5, fiber optic cable, etc.), a wireless infrastructure (e.g., radio frequency, cellular, microwave, satellite, Bluetooth, etc.), and/or other communication connection technologies. In some examples, inbound data may be routed through the communication interface(s) 114 before being directed to the processor(s) 110. In some examples, outbound data from the processor(s) 110 may be routed through the communication interface(s) 114 before being directed to a communications network (e.g., communications network 118). The communication interface(s) 114 may therefore receive inputs, such as data, from the processor(s) 110 and/or any other component described herein. For example, the communication interface(s) 114 may be configured to transmit data to, and/or receive data from, one or more network devices (e.g., Wi-Fi routers, etc.). In some examples, the communication interface(s) 114 may act as a conduit for data communicated between various internal systems (or components) of the product scanner 102 and the processor(s) 110.

In the depicted example, the communications network 118 may be the Internet, an intranet, and/or any other examples of a communications network as described herein for sending and/or receiving data between two or more computing devices (e.g., product scanner 102, point-of-sale device(s) 116, etc.). The communications network 118, as shown, may comprise one or more of a Wi-Fi circuit (e.g., Wi-Fi router), ZigBee circuit, Bluetooth circuit (e.g., Bluetooth 5.2 chip, Bluetooth Low Energy (BLE) chip, etc.), LTE circuit, and/or any other communications protocol, hardware, software, and/or firmware. In some examples, the communications network 118 may permit remote communication between two or more computing devices including, without limitations, servers, computers, mobile devices, remote systems and services (e.g., machine learning system(s) 120, cloud services, webservices, etc.), and/or the like as described herein. In some examples, the communications network 118 may be representative of any type of communication network(s), data networks, voice network(s), and/or the like. In some examples, the communications network 118 may be implemented using wired infrastructure (e.g., cable, CAT5, fiber optic cable, etc.), a wireless infrastructure (e.g., radio frequency, cellular, microwave, satellite, Wi-Fi, Bluetooth, etc.), one or more network devices (e.g., Wi-Fi routers, base stations, relay servers, etc.), and/or any other communications connection technologies. In some examples, the communications network 118 may comprise one or more communications channels, tunnels, Virtual Private Networks (VPNs), and/or the like. In some examples, the communications network 118 may be implemented using encryption techniques (e.g., end-to-end encryption, etc.).

In the depicted example, the point-of-sale device(s) 116 may be any system for processing a sales transaction. For example, the point-of-sale device(s) 116 may be a computing device communicatively coupled to one or more of a cash register, a touchscreen monitor, a payment terminal (e.g., card reader, cash recycler, etc.), a receipt printer, and/or the like as described herein. In some examples, the point-of-sale device(s) 116 may comprise a self-checkout point-of-sale system. In some such examples, the point-of-sale device(s) 116 may comprise, at least in part, the product scanner 102 as described above.

In the depicted example, the machine learning system(s) 120 may be any computing device and/or non-transitory machine-readable medium as described herein that is configured to manage and/or store datasets (e.g., training data, etc.), features, labels, models, and/or performance metrics for a machine learning model. As shown, the machine learning system(s) 120 comprises the database(s) 120A. In some examples, the database(s) 120A may be any database comprising a structured repository of data for facilitating the training and/or evaluation of machine learning models and/or algorithms. In some examples, the database(s) 120A may store labeled and/or unlabeled data and, in such examples, may further enable the iterative refinement of models and/or algorithms through supervised, unsupervised, and/or reinforcement learning techniques. Additionally, or alternatively, the database(s) 120A may incorporate mechanisms for data preprocessing (e.g., deletion of redundant data, etc.), feature extraction, and/or real-time (or near-real-time) updates (e.g., using data collected from live customer checkouts, data comprising a trusted data flag or marker, etc.) to ensure optimal performance and/or accuracy of the machine learning models.

In some examples, the machine learning system(s) 120 may comprise a webservice, cloud service, and/or any other remotely hosted machine learning systems. In some examples, the machine learning system(s) 120 may comprise a radar machine learning model, algorithm, and/or dataset for identifying objects based, at least in part, on radar imaging data (or any other radar data). In some examples, the machine learning system(s) 120 may comprise a computer vision machine learning model, algorithm, and/or dataset for identifying objects based, at least in part, on video (and/or any other imaging data). In some examples, the database(s) 120A may comprise a lookup table associated with one or more of a barcode, Universal Product Code (UPC), Price Look-up Code (PLU), and/or any other product indicia described herein. In some examples, the database(s) 120A may comprise training data for training a radar machine learning model and/or a computer vision machine learning model. For example, the database(s) 120A may comprise a radar-product database comprising radar-product training data that associates known three-dimensional layer data (e.g., radar imaging data, etc.) with one or more known products (e.g., products previously scanned and identified with radar imaging data). In some examples, employees may compile and/or update (e.g., add or remove data, correct errors, etc.) a radar-product database when taking inventory. In some examples, only data flagged from a trusted source may be added to the radar-product database. For example, products scanned by customers may be compared to the radar-product database to identify one or more products, however, data generated when products are scanned by customers may not be added as training data to the radar-product database (e.g., because the products may have been tampered with prior to being scanned).

FIG. 2A illustrates a top-down view of an example scanner system and a radar field-of-view, according to example embodiments of the present disclosure. As depicted in FIG. 2A, the scanner system 200 may comprise, at least in part, the scanner system 100 as described above in connection with FIG. 1. The scanner system 200, as shown, comprises the product scanner 102, a radar field-of-view 202, a power-on detection zone 204, a wake-up detection zone 206, a scan region 208, a vision capture region 209, and an indicia scan region 210. In some examples, the radar field-of-view 202 comprises (or defines) the power-on detection zone 204, the wake-up detection zone 206, the scan region 208, and/or the vision capture region 209. As shown in the depicted example, the scanner system 200 may be a self-checkout station (or the like) configured for a customer (e.g., person 212) to scan one or more products and/or identify each product (e.g., using a barcode, visions systems, radar imaging, etc.) to one or more point-of-sale devices that can facilitate the purchase of the product(s). In some such examples, the scanner system 200 may comprise the point-of-sale device(s) 116, as described above for FIG. 1, to facilitate sales and/or financial transactions.

As shown in FIG. 2A, various detection zones (or regions) are configured, at least in part, within the radar field-of-view 202 to cause (or trigger) one or more respective responses from the scanner system 200. For example, when not providing service to a customer the scanner system 200 may enter a low-power state (e.g., 30 seconds, or another number, after a sales transaction has completed without receiving additional user inputs) to conserve energy. In the low-power state the radar system 106 of the product scanner 102 may remain, at least in part, active to monitor power-on detection zone 204 for the presence of a person (e.g., the person 212, a customer, an employee, etc.). In such examples, when the person 212 enters the power-on detection zone 204 of radar field-of-view 202, then the radar system 106 may generate an activation (or power-on) signal that is configured to power-on one or more components of the scanner system 200 (e.g., indicia scanner 104, a computing device, touchscreen monitor, etc.). For instance, the product scanner 102 and/or the point-of-sale device(s) 116 may turn-on (or power-on) in response to the person 212 entering, at least in part, the power-on detection zone 204. In some such examples, the radar system 106 may transmit the activation signal (e.g., using communications interface(s) 114, etc.) to the one or more components of the scanner system 200 that require activation (e.g., to complete a sales transaction with a customer).

In some examples, upon receipt of an activation signal (e.g., using communications interface(s) 114, etc.), the one or more components of the scanner system 200 may power-on but may remain in a stand-by mode (e.g., power-saving mode, sleep mode, etc.) to conserve energy and/or to provide the customer with an improved sales interaction. For example, when the person 212 enters the power-on detection zone 204 (as described above), the indicia scanner 104 may power-on but remain, at least in part, inactive, such as by dimming or not activating the light source(s) 104A (or other forms of illumination). It should be appreciated that by dimming or not activating the light source(s) 104A the scanner system 200 may advantageously conserve electrical energy and/or improve a self-checkout experience for a customer (e.g., by preventing unnecessary illumination from irritating a customer's eyes or interfering with their vision).

As shown in the depicted example, the indicia scanner 104 may wake-up (or fully activate) when a product 214 enters the wake-up detection zone 206. For example, the person 212 may remove the product 214 from the cart 216 and move it through the wake-up detection zone 206 toward the scan region 208 and/or the indicia scan region 210 (e.g., to scan the product indicia associated with the product 214). In some such examples, the indicia scanner 104 (or other component of the scanner system 200) may wake-up in response to the product 214 (or other object) entering, at least in part, the wake-up detection zone 206 of the radar field-of-view 202. For instance, the radar system 106 may generate a wake (or power-on) signal that is configured to wake-up one or more components of the scanner system 200 (e.g., indicia scanner 104, a computing device, touchscreen monitor, etc.). In some such examples, the radar system 106 may transmit the wake signal (e.g., using communications interface(s) 114, etc.) to the one or more components of the scanner system 200. For example, the wake signal may cause (or allow) the indicia scanner 104 to undim or activate the light source(s) 104A and/or other forms of illumination (e.g., to facilitate scanning a barcode, etc.). In some examples, the radar system 106 may function as a wake-up system for other components. In some such examples, as a wake-up system the radar system 106 may be positioned in the product scanner 102 to overlap the radar field-of-view 202 with the indicia scan region 210 and any space beyond the indicia scan region 210. In such examples, the radar system 106 may be used to wake-up the indicia scanner (or the like) when an object enters the indicia scan region 210 and may be configured to indicate whether an object has left (or exited) the indicia scan region 210 to make the indicia scanner re-enter a sleep mode or other power-saving mode (e.g., after a 15 second, or another number, sleep timer has elapsed). Additionally, or alternatively, the radar system 106 may be used for missed scan detection by determining when an object passes through the radar field-of-view 202 and then exits without the indicia scanner 104 decoding a product indicia. It should be appreciated that a missed scan detection may occur in real-time (or near-real-time) and provide a notification (e.g., to the customer or an employee) before the customer moves on to scan the next item. In some examples, the radar system 106 may be configured to ignore objects (e.g., bags, products, etc.) sitting beyond the indicia scan region 210. For example, if the scanner system comprises a conveyor belt for products (e.g., such as at a grocery store checkout with a cashier) items that pile up on the conveyer may be (at least temporarily) ignored by the radar system 106 to prevent the indicia scanner 104 from continuously attempting to scan (or decode a product indicia). It should be understood that the decode location in the indicia (and/or camera) field-of-view may be matched up against the object location in the radar field-of-view 202 to cause capturing of data.

In some examples, the indicia scanner 104 and/or the vision system 108 may initiate (e.g., based on the wake signal) the capturing of data (e.g., image frames, etc.) before the product 214 enters a respective field-of-view (e.g., the indicia scan region 210, a camera field-of-view, etc.) to maximize the amount of data (e.g., the number of frames) captured. As shown in the depicted example, the radar system 106 may define a scan region 208 (e.g., within the radar field-of-view 202), at least in part, around the indicia scan region 210 of the indicia scanner 104. In some such examples, the indicia scanner 104 may be configured to scan (or decode) a barcode (or other product indicia described herein) over the indicia scan region 210 in response to the product 214 being detected within the scan region 208. In some examples, the indicia scanner 104 may be configured to decode a product indicia and/or send (or transmit) a decoded product indicia when a product (e.g., product 214, etc.) is decoded from within the scan region 208 (and/or when the product 214 has passed through that region). It should be appreciated that this can advantageously prevent, and/or filter out, accidental decodes of products that are placed (or located) outside the scan region 208 but may still be within range of the indicia scanner 104 (e.g., products that have already been scanned, products that are waiting to be scanned, etc.). For example, when the radar system 106 detects the product 214 in the scan region 208, then the radar system 106 may generate a command signal that is configured to cause (or allow) the indicia scanner 104 to capture (and/or decode) a product indicia (e.g., a barcode, etc.).

As shown in the depicted example, the radar system 106 may define a vision capture region 209 (e.g., within the radar field-of-view 202), at least in part, around the scan region 208. In some examples, when the radar system 106 detects the product 214 in the vision capture region 209, then the radar system 106 may generate a command signal that is configured to cause the vision system 108 to capture an image or video of a product (or, at least in part, the vision capture region 209). It should be appreciated that causing (or allowing) the indicia scanner 104 and/or the vision system 108 to capture data based on a detection of the product 214 in the scan region 208 and/or the vision capture region 209 may be associated with several advantages. One advantage, for such example implementations, is a reduction in the burden placed on system resources. For example, continuous (or intermittent) data capture (e.g., by the indicia scanner 104 and/or the vision system 108) may consume computing resources (e.g., processing power of processor(s) 110, communications bandwidth of communications interface(s) 114, etc.) unnecessarily (e.g., when a product is not present in, at least, the scan region 208 and/or the vision capture region 209) and, thus, only capturing data when a product is detected by the radar system 106 may facilitate more efficient use of the available resources of the scanner system 200. In some examples, the radar system 106 may allow decoded information (and/or captured video) to be sent to a host (e.g., server, point-of-sale device(s) 116, machine learning system(s) 120, etc.) only when the radar system 106 detects the product 214 in the scan region 208 (and/or the vision capture region 209). In some such examples, the radar system 106 may block decoded information (and/or captured video) from being sent to a host (e.g., server, point-of-sale device(s) 116, machine learning system(s) 120, etc.) when the scan region 208 (and/or the vision capture region 209) is determined to be empty. It should be appreciated that blocking decoded product indicia information (e.g., for products outside of the scan region 208) may prevent, and/or assist in filtering out, accidental decodes. Additionally, or alternatively, it should be appreciated that blocking captured video (e.g., for products outside of the vision capture region 209) may prevent, and/or assist in filtering out, video data (or the like) (e.g., that is not capturing products associated with the sales transaction, that is not capturing/detecting scan avoidance, etc.). In some examples, the radar system 106 may block a sales transaction and/or flag a self-checkout station (e.g., to an employee, etc.) when an object (e.g., product 214, etc.) moves from the cart 216 through the radar field-of-view to the bag 218 without being scanned by the indicia scanner 104. In some such examples, the radar system 106 may cause one or more cameras (e.g., security cameras, camera(s) 108A of the vision system 108, etc.) to record the person 212, the cart 216, the bag 218, and/or any other portion of the environment around the scanner system 200 (e.g., for further security review, such as by a loss prevention employee).

FIG. 2B illustrates a perspective view of an example scanner system and a radar field-of-view, according to example embodiments of the present disclosure. As shown in FIG. 2B, the scanner system 200 is shown from a perspective view to help illustrate various example dimensions for the power-on detection zone 204, the wake-up detection zone 206, the scan region 208, and the vision capture region 209. The power-on detection zone 204, the wake-up detection zone 206, the scan region 208, and the vision capture region 209 are depicted in FIG. 2B with a cubic form for illustrative purposes and to facilitate a clearer description of the example implementations described herein. It should be understood that the power-on detection zone 204, the wake-up detection zone 206, the scan region 208, the vision capture region 209, and/or any other similar features, zones, or regions as described herein may comprise any size, shape, and/or dimensions and should not be limited to a cubic form unless understood in the context of a particular example described herein.

The power-on detection zone 204, as shown, may comprise (or define) at least a portion of the radar field-of-view 202 disposed in front of a self-checkout station. In the depicted example, the power-on detection zone 204 may be configured at a position to cover the head, shoulders, and/or torso of a customer. In other examples, the power-on detection zone 204 may be configured to extend from the highest point-of-view (e.g., the ceiling, 9 feet or another number above the ground, etc.) in the radar field-of-view 202 to the lowest point-of-view (e.g., the floor, 2 feet or another number above the ground, etc.) of the radar field-of-view 202. In some examples, the location of the power-on detection zone 204 may be defined by one or more of a coordinate system (e.g., cartesian, polar, etc.), an angle, and/or a distance from the radar system 106 (e.g., the antenna(s) 106B, etc.). In some examples, one or more radar parameters described herein may define the location of the power-on detection zone 204 and, in such examples, the location of the power-on detection zone 204 may be adjusted by modifying the one or more radar parameters associated with the location of the power-on detection zone 204. In some examples, the power-on detection zone 204 (or the like) as described herein may comprise a width equal to (or less than) the width of the radar field-of-view 202. For example, as shown in FIGS. 2A and 2B, the radar field-of-view 202 may widen as the radar field-of-view 202 extends away from the product scanner 102 (e.g., comprising the radar system 106). In some such examples, the width (or side-to-side boundaries) of the power-on detection zone 204 (or the like) may be the same as the width (or side-to-side boundaries) of the radar field-of-view 202 (e.g., along the distances associated with, or defined by, the power-on detection zone 204 (or the like)).

The wake-up detection zone 206, as shown, may comprise (or define) at least a portion of the radar field-of-view 202 disposed above and/or in front of a self-checkout station. In the depicted example, the wake-up detection zone 206 may be configured to cover a larger detection zone above and around the vision capture region 209, the scan region 208, and/or the indicia scan region 210 (e.g., to initiate data capture as described above in connection with FIG. 2A). In some examples, the wake-up detection zone 206 may be configured to cover a larger detection zone above and around the vision capture region 209, the scan region 208, and/or the indicia scan region 210 to detect movement of products around the indicia scan region 210. Upon detecting the movement of one or more products around the indicia scan region 210 (e.g., without decoding a barcode or the like) the radar system 106 may flag the self-checkout station to an employee (or activate other security measures as described herein). In some examples, the wake-up detection zone 206 may be configured to extend from the highest point-of-view (e.g., the ceiling, 3 feet or another number above the countertop comprising the indicia scan region 210, etc.) in the radar field-of-view 202 to the lowest point-of-view (e.g., the countertop comprising the indicia scan region 210) of the radar field-of-view 202. In some examples, the location of the wake-up detection zone 206 may be defined by one or more of a coordinate system (e.g., cartesian, polar, etc.), an angle, and/or a distance from the radar system 106 (e.g., the antenna(s) 106B, etc.). In some examples, one or more radar parameters described herein may define the location of the wake-up detection zone 206 and, in such examples, the location of the wake-up detection zone 206 may be adjusted by modifying the one or more radar parameters associated with the location of the wake-up detection zone 206. In some examples, the wake-up detection zone 206 (or the like) as described herein may comprise a width equal to (or less than) the width of the radar field-of-view 202. For example, as shown in FIGS. 2A and 2B, the radar field-of-view 202 may widen the further the radar field-of-view 202 extends away from the product scanner 102 (e.g., comprising the radar system 106). In some such examples, the width (or side-to-side boundaries) of the wake-up detection zone 206 (or the like) may be the same as the width (or side-to-side boundaries) of the radar field-of-view 202 (e.g., along the distances associated with, or defined by, the wake-up detection zone 206 (or the like)).

The scan region 208, as shown, may comprise (or define) at least a portion of the radar field-of-view 202 disposed above and/or adjacent a countertop of a self-checkout station comprising the indicia scan region 210. In some examples, the scan region 208 may be configured to cover any and/or all space above the countertop comprising the indicia scan region 210 within the radar field-of-view 202. Upon detecting the movement of one or more products within the scan region 208, the radar system 106 may cause (or allow) the indicia scanner 104 to decode a product indicia within the indicia scan region 210. In some examples, the scan region 208 may be configured to extend above the countertop comprising the indicia scan region 210 by a vertical distance equal to a decoding distance associated with the indicia scanner 104. In some examples, the decoding distance may be a maximum distance (e.g., 9 inches, 25 cm, or any other number) from which the indicia scanner 104 may decode a product indicia (e.g., barcode, etc.). In some examples, the location of the scan region 208 may be defined by one or more of a coordinate system (e.g., cartesian, polar, etc.), an angle, and/or a distance from the radar system 106 (e.g., the antenna(s) 106B, etc.). In some examples, one or more radar parameters described herein may define the location of the scan region 208 and, in such examples, the location of the scan region 208 may be adjusted by modifying the one or more radar parameters associated with the location of the scan region 208. In some examples, the scan region 208 (or the like) as described herein may comprise a width equal to (or less than) the width of the radar field-of-view 202. For example, as shown in FIGS. 2A and 2B, the radar field-of-view 202 may widen the further the radar field-of-view 202 extends away from the product scanner 102 (e.g., comprising the radar system 106). In some such examples, the width (or side-to-side boundaries) of the scan region 208 (or the like) may be the same as the width (or side-to-side boundaries) of the radar field-of-view 202 (e.g., along the distances associated with, or defined by, the scan region 208 (or the like)).

The vision capture region 209, as shown, may comprise (or define) at least a portion of the radar field-of-view 202 disposed above and/or adjacent a countertop of a self-checkout station. In some examples, the vision capture region 209 may be configured to cover any and/or all space above the countertop comprising the indicia scan region 210 (e.g., up to the chest or shoulders of a user, up to the ceiling, etc.) within the radar field-of-view 202. Upon detection one or more products within the vision capture region 209, the radar system 106 may cause (or allow) the vision system 108 to capture video data (or the like) representative of, at least in part, a product, a user, the vision capture region 209, and/or the like as described herein. In some examples, the location of the vision capture region 209 may be defined by one or more of a coordinate system (e.g., cartesian, polar, etc.), an angle, and/or a distance from the radar system 106 (e.g., the antenna(s) 106B, etc.). In some examples, one or more radar parameters described herein may define the location of the vision capture region 209 and, in such examples, the location of the vision capture region 209 may be adjusted by modifying the one or more radar parameters associated with the location of the vision capture region 209. In some examples, the vision capture region 209 (or the like) as described herein may comprise a width equal to (or less than) the width of the radar field-of-view 202. For example, as shown in FIGS. 2A and 2B, the radar field-of-view 202 may widen the further the radar field-of-view 202 extends away from the product scanner 102 (e.g., comprising the radar system 106). In some such examples, the width (or side-to-side boundaries) of the vision capture region 209 (or the like) may be the same as the width (or side-to-side boundaries) of the radar field-of-view 202 (e.g., along the distances associated with, or defined by, the vision capture region 209 (or the like)).

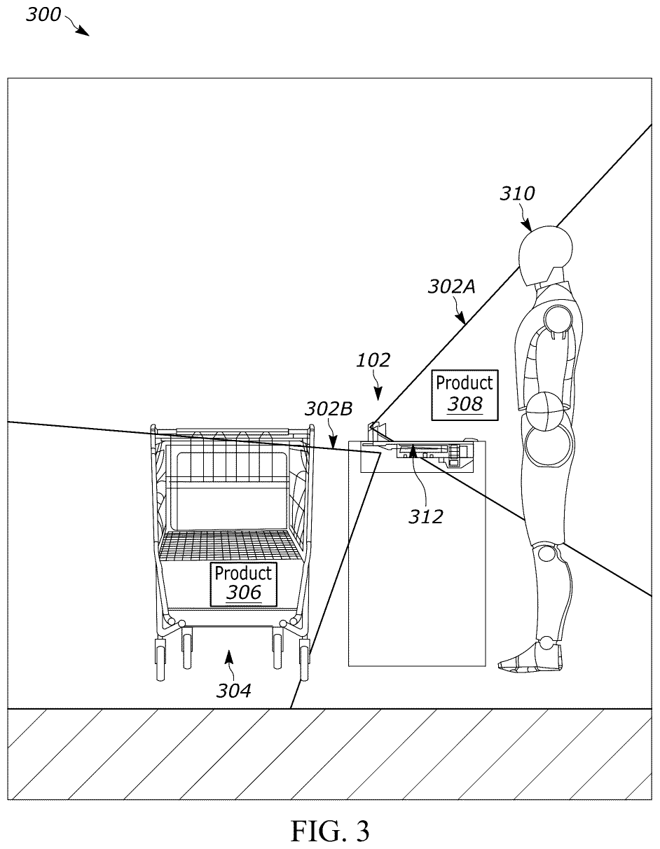

FIG. 3 illustrates a side view of an example scanner system and at least one radar field-of-view, according to example embodiments of the present disclosure. As depicted in FIG. 3, the scanner system 300 may comprise, at least in part, the scanner system 100 and/or the scanner system 200 as described above in connection with FIGS. 1, 2A, and 2B. The scanner system 300, as shown, comprises the product scanner 102, a first radar field-of-view 302A, and a second radar field-of-view 302B. As shown in the depicted example, the scanner system 300 may be a cashier checkout station (or the like) configured for an employee (e.g., person 310, cashier, etc.) to assist a customer during the checkout process. For example, the employee (e.g., person 310, etc.) may scan one or more products (e.g., product 308, etc.) and/or identify each product (e.g., using a barcode, visions systems, radar imaging, etc.) to one or more point-of-sale devices that can facilitate the sales transaction. In some such examples, the scanner system 300 may comprise the point-of-sale device(s) 116, as described above for FIG. 1.

As shown in FIG. 3, a person 310 may scan the product 308 using the indicia scan region 312 of the product scanner 102 (e.g., comprising the indicia scanner 104). In some such examples, the product scanner 102 (e.g., comprising the radar system 106) may detect and/or identify the product 308 using the first radar field-of-view 302A. For example, the first radar field-of-view 302A may penetrate (or see through) the packaging of the product 308 and determine whether additional objects are hidden within the product 308. Additionally, or alternatively, as shown the product scanner 102 (e.g., comprising the radar system 106) may detect and/or identify the product 306 in the bottom of the cart 304 using the second radar field-of-view 302B. In some such examples, the radar system 106 may comprise two or more radar chips (e.g., radar chip(s) 106A) and/or antennas (e.g., antenna(s) 106B). For example, the product scanner 102 may be configured with a first radar chip and antenna circuit to produce the first radar field-of-view 302A and monitor the space over the indicia scan region 312 and/or behind the product scanner 102 (e.g., where the employee stands). In addition, the product scanner 102 may be configured with a second radar chip and antenna circuit to produce the second radar field-of-view 302B and monitor the aisle in front of the product scanner 102 (e.g., where the customer stands and pushes the cart 304).

As shown in the depicted example, the second radar field-of-view 302B may detect and/or identify the product 306 in the bottom of the cart 304 and may alert an employee and/or (automatically) identify the product 306 to the point-of-sale device (e.g., point-of-sale device(s) 116). In some examples, a radar antenna can be positioned in the lower part of a bioptic scanner housing (e.g., as shown in FIG. 3) in a plastic portion of the housing (e.g., clear of metals) with a radar field-of-view that can see through wooden counter furniture (or other non-metal materials) to a cart (e.g., cart 304) passing by the rear of the bioptic. Additionally, or alternatively, additional radar modules (e.g., comprising radar chip(s) 106A) and/or antenna(s) 106B) may be configured in one or more separate housing around a point-of-sale device to provide additional radar field-of-view coverage. For example, additional radar modules may be wired (or wirelessly coupled, such as with Bluetooth or the like) to the radar system 106 at a remote location above, below, and/or adjacent the point-of-sale counter. It should be appreciated that one advantage to additional radar modules is that there may be no need to cut holes in the store's furniture or fixtures (e.g., a scanner system housing) which may leave them susceptible to additional dirt and/or damage. In some examples, additional radar modules may be positioned (or disposed) over a bagging area (e.g., comprising the bag 218 shown in FIGS. 2A and 2B) to detect items placed in the bagging area that may bypass the radar field-of-view 202.

In some examples, the product scanner 102 may be configured with a single radar chip and antenna circuit to produce the first radar field-of-view 302A and the second radar field-of-view 302B. For example, the radar chip(s) 106A and/or the antenna(s) 106B may be mechanically coupled (e.g., using fasteners, adhesive, etc.) to a radar platform that may swivel, rotate, tilt, translate, and/or the like (e.g., using a servomotor, stepper motor, etc.) to position a radar field-of-view in either direction and/or position as represented by the first radar field-of-view 302A and the second radar field-of-view 302B. In some examples, the product scanner 102 may adjust one or more radar parameters (e.g., chirp parameters, etc.) to shift, rotate, and/or reposition a radar field-of-view from (i) the first radar field-of-view 302A to the second radar field-of-view 302B, (ii) the second radar field-of-view 302B to the first radar field-of-view 302A, and/or (iii) any other position between the first radar field-of-view 302A to the second radar field-of-view 302B. In some examples, the radar system 106 may generate a command signal and transmit it to the point-of-sale device to render a message and/or other graphical user interface indication to an employee (e.g., based on a product being detected in the second radar field-of-view 302B).

FIG. 4 illustrates an example flowchart for detecting product data using an example scanner system, according to example embodiments of the present disclosure. As shown, the process 400 may be used for detecting product data using an example scanner system (e.g., scanner system 100, scanner system 200, scanner system 300, or the like). The operations of the process 400 may represent a series of instructions comprising computer readable machine code executable by a processing unit (e.g., processor(s) 110) of the product scanner 102 (or any other computing device described herein), although various operations may also be implemented in, or using, one or more specifically designed logic circuits (e.g., ASIC, etc.). In some examples, the computer readable machine codes may be comprised of instructions selected from a native instruction set of at least one processor (e.g., processor(s) 110) and/or an operating system of the product scanner 102 (or any other computing device described herein). In some examples, the process 400 may be performed, at least in part, by one or more components of an example scanner system (e.g., scanner system 100, scanner system 200, scanner system 300, or the like). For example, the process 400 may be performed by an apparatus (e.g., scanner system 100, product scanner 102, radar system 106, point-of-sale device(s) 116, etc.) comprising at least one processor (e.g., processor(s) 110) and at least one machine-readable storage device (e.g., memory 112) storing processor executable instructions which, when executed using the at least one processor, causes the apparatus to perform, at least in part, one or more of operations 402-420 (and/or the like) as described herein. In some examples, the process 400 may comprise one or more operations, techniques, and/or features as described above in connection with at least FIGS. 1, 2A, 2B, and/or 3. In some examples, the process 400 may represent a computer-implemented method for detecting product data using an example scanner system.

As shown in FIG. 4, the process 400 may begin at operation 402, at which an apparatus may detect a person in a power-on detection zone. For example, a customer (e.g., person 212) may walk into (or enter) a power-on detection zone 204 of the radar field-of-view 202 as shown in FIG. 2A and described above. In some examples, the operation 402 may comprise generating (e.g., chirping continuously and/or periodically, such as every second or another amount of time) electromagnetic waves based on radar parameters. In some examples, the operation 402 may comprise transmitting the electromagnetic waves and the electromagnetic waves may define the radar field-of-view based, at least in part, on one or more radar parameters. In some examples, the operation 402 may comprise receiving (e.g., by the radar system 106) one or more reflections (or echoes) of electromagnetic waves. In some such examples, one or more reflections (or echoes) of electromagnetic waves may have bounced (or echoed) off of at least one surface of the person (or object) in the power-on detection zone. In some examples, the operation 402 may comprise detecting (e.g., using the radar system 106) a person within the power-on detection zone. In some examples, the operation 402 may comprise generating (e.g., using the radar system 106, processor(s) 110, etc.) an activation signal configured to power-on one or more computing devices. In some examples, the operation 402 may comprise transmitting (e.g., using the radar system 106, processor(s) 110, etc.) the activation signal via a communications interface (e.g., communications interface(s) 114) to one or more computing devices and/or components of a scanner system (e.g., the indicia scanner 104, the point-of-sale device(s) 116, the vision system 108, etc.).

The process 400 may continue at operation 404, at which the apparatus may power-on an indicia scanner, point-of-sale device and/or vision system. In some examples, the operation 404 may comprise receiving (e.g., by the indicia scanner 104, by the point-of-sale device(s) 116, by the vision system 108, etc.) the activation signal via a communications interface (e.g., via communications interface(s) 114). In some examples, the indicia scanner, the point-of-sale device, and/or the vision system may power-on but may remain in a stand-by (or sleep) mode to conserve energy and/or to provide an improved sales interaction for a customer (as described above in connection with at least FIG. 2A).

The process 400 may continue at operation 406, at which the apparatus may detect a product in a wake-up detection zone. For example, a customer (e.g., person 212) may remove a product (e.g., product 214) from a shopping cart (e.g., cart 216) and move the product toward the indicia scan region 210 and into the wake-up detection zone 206 of the radar field-of-view 202 as shown in FIG. 2A and described above. In some examples, the operation 406 may comprise generating (e.g., chirping continuously and/or periodically, such as every second or another amount of time) electromagnetic waves based on one or more radar parameters. In some examples, the operation 406 may comprise receiving (e.g., by the radar system 106) one or more reflections (or echoes) of electromagnetic waves. In some such examples, one or more reflections (or echoes) of electromagnetic waves may bounce, reflect, and/or echo off of at least one surface of the product (or object) in the wake-up detection zone. In some examples, the operation 406 may comprise detecting (e.g., using the radar system 106) a product within the wake-up detection zone. In some examples, the operation 406 may comprise generating (e.g., using the radar system 106, processor(s) 110, etc.) a wake signal configured to wake-up one or more computing devices and/or components of a scanner system (e.g., the indicia scanner 104, the point-of-sale device(s) 116, the vision system 108, etc.). In some examples, the operation 406 may comprise transmitting (e.g., using the radar system 106, processor(s) 110, etc.) the wake signal via a communications interface (e.g., communications interface(s) 114) to one or more computing devices and/or components of a scanner system (e.g., the indicia scanner 104, the point-of-sale device(s) 116, the vision system 108, etc.).

The process 400 may continue at operation 408, at which the apparatus may wake-up the indicia scanner. For example, the wake signal (described above at operation 406) may cause (or allow) the indicia scanner 104 to undim or activate the light source(s) 104A and/or other forms of illumination (e.g., to facilitate scanning a barcode, etc.) as described above in connection with FIG. 2A. In some examples, the operation 408 may comprise rendering a graphical user interface on a display screen of the point-of-sale device(s) 116 (e.g., to initiate a sales transaction). In some examples, the operation 408 may comprise initializing camera(s) 108A of the vision system 108 and/or capturing image data (e.g., video, still images, etc.) via camera(s) 108A of the vision system 108. For example, the vision system 108 may capture video of the product as it enters the wake-up detection zone and passes across an in-counter indicia scanner.

The process 400 may continue at operation 410, at which the apparatus may detect the product in a scan region and/or a vision capture region For example, the scan region 208 (and/or the vision capture region 209) may be configured to cover any and/or all space above the countertop comprising the indicia scan region 210 within the radar field-of-view 202 (as described above in connection with FIG. 2A) and as a product passes across the indicia scan region 210 it may pass through the scan region 208 (and/or the vision capture region 209). In some examples, the operation 410 may comprise generating (e.g., chirping continuously and/or periodically, such as every second or another amount of time) electromagnetic waves based on one or more radar parameters. In some examples, the operation 410 may comprise receiving (e.g., by the radar system 106) one or more reflections (or echoes) of electromagnetic waves. In some such examples, one or more reflections (or echoes) of electromagnetic waves may bounce, reflect, and/or echo off of at least one surface of the product (or object) in the scan detection zone. In some examples, the operation 410 may comprise detecting (e.g., using the radar system 106) a product within the scan detection zone. In some examples, the operation 410 may comprise generating (e.g., using the radar system 106, processor(s) 110, etc.) a command signal configured to cause one or more computing devices and/or components of a scanner system (e.g., the indicia scanner 104, the point-of-sale device(s) 116, the vision system 108, etc.) to perform one or more operations (e.g., capture indicia data, capture video, etc.). In some examples, the operation 410 may comprise transmitting (e.g., using the radar system 106, processor(s) 110, etc.) the command signal via a communications interface (e.g., communications interface(s) 114) to one or more computing devices and/or components of a scanner system (e.g., the indicia scanner 104, the point-of-sale device(s) 116, the vision system 108, etc.).

The process 400 may continue at operation 412, at which the apparatus may capture indicia data. In some examples, the operation 412 may comprise capturing (or decoding) (e.g., using the indicia scanner 104) indicia data from a product indicia (e.g., barcode, QR code, etc.). In some examples, the indicia scanner 104 may capture (or decode) indicia data in response to receiving a command signal (as described above at operation 410). For example, the radar system 106 may detect a product in the scan region 208 (as described above) and, in response, the indicia scanner 104 may decode a product indicia (e.g., barcode, etc.) associated with the product in the scan region 208. In some examples, the operation 412 may comprise capturing (e.g., using the vision system 108) image data and/or video data of a product. In some examples, the vision system 108 may capture (or decode) indicia data in response to receiving a command signal (as described above at operation 410). For example, the radar system 106 may detect a product in the vision capture region 209 (as described above) and, in response, the vision system 108 may capture (or record) the product in the vision capture region 209.

The process 400 may continue at operation 414, at which the apparatus may capture three-dimensional layer data. For example, when a product pauses (at last temporarily) for the indicia scanner 104 to decode a barcode (or the like), the radar system 106 may capture three-dimensional layer data representative of at least one (interior and/or exterior) surface of the product and/or product packaging. In some examples, the operation 414 may comprise generating (e.g., chirping continuously and/or periodically, such as every second or another amount of time) electromagnetic waves based on one or more radar parameters. In some examples, the operation 414 may comprise receiving a first reflection of the electromagnetic waves (e.g., from a surface of a product and/or product package). In some such examples, the first reflection may indicate (or represent) the first three-dimensional layer data. For example, the first reflection may indicate (or represent) a size, shape, velocity, direction of movement, material (e.g., carboard, plastic, etc.), and/or the like as described herein for a product and/or product package. In some examples, the operation 414 may comprise receiving a second reflection of the electromagnetic waves (e.g., from a surface of a product and/or product package). In some such examples, the second reflection may indicate (or represent) the second three-dimensional layer data. For example, the second reflection may indicate (or represent) a size, shape, velocity, direction of movement, material (e.g., carboard, plastic, etc.) and/or the like as described herein for a product and/or product package. In some examples, the first three-dimensional layer data and/or the second three-dimensional layer data may each further comprise, indicate, or represent doppler shift data indicating a velocity vector associated with one or more reflective surfaces of a product (or object). In some examples, the operation 414 may comprise capturing (e.g., using the radar system 106) first three-dimensional layer data representative of an exterior feature of a product disposed within a radar field-of-view. In some such examples, the exterior feature of the product may be one or more of a geometric shape, a dimension, a material, and/or the like as described herein in association with product and/or packaging. In some examples, the operation 414 may comprise capturing (e.g., using the radar system 106) second three-dimensional layer data representative of an interior feature of the product disposed within the radar field-of-view. In some such examples, the interior feature of the product may be one or more of a geometric shape, a dimension, a material, and/or the like of a product at least partially enclosed within packaging (e.g., a cardboard box, a blister pack, a plastic shell, etc.).

The process 400 may continue at operation 416, at which the apparatus may determine whether the indicia data and the three-dimensional layer data match the same product. In some examples, the operation 416 may comprise storing first three-dimensional layer data representative of an exterior feature of a product and/or storing second three-dimensional layer data representative of an interior feature of the product to a memory device (e.g., memory 112, etc.). In some examples, the operation 416 may comprise accessing (or retrieving) radar-product training data from a radar-product database (e.g., the database(s) 120A). In some such examples, radar-product training data may associate known three-dimensional layer data with one or more known products. In some examples, the operation 416 may comprise comparing (e.g., using a radar-product model of the machine learning system(s) 120), at least in part, the first three-dimensional layer data and/or the second three-dimensional layer data to the radar-product training data. For example, a radar-product model may compare the first three-dimensional layer data (e.g., representing the exterior packaging of the product) to radar-product training data to identify a known product and/or a known package with at least one of a similar (or the same) size, shape, material, and/or the like as the first three-dimensional layer data. Additionally, or alternatively, the radar-product model may compare the second three-dimensional layer data (e.g., representing the interior of the product or package) to the radar-product training data to identify a known product and/or a known package with at least one of a similar (or the same) size, shape, material, and/or the like as the second three-dimensional layer data. In some examples, the radar-product model may be part of a larger product model (e.g., machine learning system(s) 120) that includes image data (e.g., image frames, video data, etc.). For example, a product model (e.g., of machine learning system(s) 120) may comprising one or more of a radar-product model, a vision-product model, image data, the database(s) 120A, and/or the like as described herein.

In some examples, the operation 416 may comprise determining (e.g., using a radar-product model of the machine learning system(s) 120), to within a decision threshold (e.g., equal to, or greater than, 95% certainty or another number), whether at least one of the first three-dimensional layer data and/or the second three-dimensional layer data represent a known product. In some examples, the radar-product model may identify a known product and/or package based on the first three-dimensional layer data and the radar-product model may compare the second three-dimensional layer data to the radar-product training data associated with an interior feature of the identified known product and/or package (e.g., to determine whether additional items are hidden in the scanned product and/or package). In some examples, the product information decoded from the product indicia (e.g., captured at operation 412 above) may be compared to the identified known product and/or package to determine whether the product indicia matches the identified product. In some examples, the image data and/or video data of the product (e.g., captured at operation 412 above) may be compared to the identified known product and/or package to determine whether the product in the video matches the identified product (and/or the product indicia as described above).

In an instance that the product and/or the package identified from the radar data (i.e., the first three-dimensional layer data, the second three-dimensional layer data, and/or the like) matches the product and/or package identified by a product indicia, image data, and/or video data, then the process 400 may proceed to the operation 418 as described below. In an instance that the product and/or the package identified from the radar data (i.e., the first three-dimensional layer data, the second three-dimensional layer data, and/or the like) does not match the product and/or package identified by a product indicia, image data, and/or video data, then the process 400 may proceed to the operation 420 as described below.

The process 400 may continue at operation 418, at which the apparatus may complete a transaction. In some examples, the operation 418 may comprise calculating a cost to purchase any or all products scanned by the indicia scanner 104. In some examples, the operation 418 may comprise generating a sales transaction comprising the cost to purchase any or all products scanned by the indicia scanner 104. In some examples, the operation 418 may comprise rendering (e.g., on a display device of a point-of-sale device) a summary of the sales transaction (e.g., list of products and prices, etc.) and instructions to complete a payment process (e.g., via a card reader, cash recycler, etc.). In some examples, the operation 418 may comprise processing a payment (e.g., from a customer) to complete the sales transaction to purchase one or more products. In some examples, the operation 418 may comprise rendering (e.g., on a display device of a point-of-sale device) a notification (e.g., to a customer) indicating that the sales transaction was successfully completed.

The process 400 may continue at operation 420, at which the apparatus may initiate corrective action(s). Examples of corrective actions may comprise, without limitation, one or more of rendering a notification to a customer, rendering a notification to an employee, locking a point-of-sale device, activating a security camera, and/or any other corrective actions as described herein. In some examples, the operation 420 may comprise rendering (e.g., on a display device of a point-of-sale device) a notification (e.g., to a customer) indicating that a product was not successfully identified (e.g., based on one or more of radar data, video data, indicia data, etc.). For example, the display device of a point-of-sale device may render a notification (e.g., text message, audible message, etc.) indicating that a product (e.g., identified by the radar system 106) is in the bagging area but was not scanned by the indicia scanner. Additionally, or alternatively, the display device of a point-of-sale device may render a notification indicating that a product that was scanned by the indicia scanner does not appear to be the correct product (e.g., the barcode does not match the radar data and/or the video data). Additionally, or alternatively, the display device of a point-of-sale device may render a notification indicating that a product (or package) that was scanned by the indicia scanner appears to contain one or more of an additional product and/or a different product. For example, the product indicia may have successfully been matched with the first three-dimensional layer data (e.g., the exterior radar data of the package), however, the second three-dimensional layer data (e.g., the interior radar data of the package) may not match the radar-product training data associated with product (e.g., identified by the product indicia and/or the first three-dimensional layer data). In some examples, the operation 420 may comprise blocking (or pausing) use of a point-of-sale device (e.g., self-checkout station, etc.) and notifying an employee to scan and/or verify the identity of one or more products. In some examples, the operation 420 may comprise capturing image data and/or video data (e.g., using a vision system and/or a security camera) that is representative of the environment around the point-of-sale device (e.g., self-checkout station, etc.) and/or the location of one or more persons in the environment. In some examples, the operation 420 may comprise capturing radar data (e.g., using a radar system) that is representative of the environment around the point-of-sale device (e.g., self-checkout station, etc.) and/or the location of one or more persons in the environment.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more Digital Signal Processors (DSPs), one or more Application Specific Integrated Circuits (ASICs), one or more Field-Programmable Gate Arrays (FPGAs), one or more microcontroller units (MCUs), one or more hardware accelerators, one or more special-purpose computer chips, and one or more System on a Chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may be combined, divided, re-arranged, and/or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s) and/or the like). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device”can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ...a,” “has ...a,” “includes ...a,” and/or “contains ... a,” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A product scanner, comprising:
a housing;
an indicia scanner comprising a light source, a lens, and an optical sensor, wherein the indicia scanner is configured to:
capture indicia data from a product indicia disposed within an indicia scan region defined by an optical field-of-view of the optical sensor; and
a radar system comprising a radar chip and an antenna, wherein the radar system is configured to:
capture three-dimensional layer data from a radar field-of-view.

2. The product scanner of claim 1, wherein the radar system is configured to:
capture first three-dimensional layer data representative of an exterior feature of a product disposed within a radar field-of-view, and
capture second three-dimensional layer data representative of an interior feature of the product disposed within the radar field-of-view.

3. The product scanner of claim 2, wherein the radar system further comprises:
a radar-product database comprising radar-product training data, wherein the radar-product training data associates known three-dimensional layer data with one or more known products; and
a radar-product model configured to:
compare, at least in part, the first three-dimensional layer data and the second three-dimensional layer data to the radar-product training data; and
determine, to within a decision threshold, whether at least one of the first three-dimensional layer data or the second three-dimensional layer data represent a known product.

4. The product scanner of claim 3, wherein the radar system further comprises:
a product model comprising one or more of the radar-product model and image data.

5. The product scanner of claim 2, wherein the radar system is further configured to:
generate electromagnetic waves based on radar parameters; and
transmit the electromagnetic waves, wherein the electromagnetic waves define the radar field-of-view based, at least in part, on the radar parameters.

6. The product scanner of claim 5, wherein the radar system is further configured to:
receive a first reflection of the electromagnetic waves, wherein the first reflection indicates the first three-dimensional layer data; and
receive a second reflection of the electromagnetic waves, wherein the second reflection indicates the second three-dimensional layer data.

7. The product scanner of claim 6, wherein the first three-dimensional layer data and the second three-dimensional layer data each further comprise doppler shift data indicating a velocity vector associated with one or more reflective surfaces of an object.

8. The product scanner of claim 1, wherein the radar field-of-view comprises one or more of a power-on zone, a wake-up zone, a vision capture region, and a scan region; and wherein the scan region of the radar field-of-view comprises, at least in part, the indicia scan region defined by the optical field-of-view of the optical sensor.

9. The product scanner of claim 8, wherein the radar system is further configured to:
detect a person within the power-on zone; and
cause activation of one or more of the indicia scanner or a vision system.

10. The product scanner of claim 8, wherein the radar system is further configured to:
detect an object within the wake-up zone; and
cause one or more of the indicia scanner or a vision system to exit a power-saving mode.

11. The product scanner of claim 8, wherein the radar system is further configured to:
detect an object within the scan region; and
allow the indicia scanner to capture the indicia data.

12. The product scanner of claim 8, wherein the radar system is further configured to:
detect an object within the vision capture region; and
cause a vision system to capture image data.

13. The product scanner of claim 2, further comprising:
a vision system comprising a camera, wherein the vision system is configured to capture image data representative of the product.

14. A radar system, comprising:
a radar chip; and
an antenna,
wherein the radar system is configured to:
capture first three-dimensional layer data representative of an exterior feature of a product disposed within a radar field-of-view; and
capture second three-dimensional layer data representative of an interior feature of the product disposed within the radar field-of-view.

15. The radar system of claim 14, further comprising:
a radar-product database comprising radar-product training data, wherein the radar-product training data associates known three-dimensional layer data with one or more known products.

16. The radar system of claim 15, further comprising:
a radar-product model configured to:
compare, at least in part, the first three-dimensional layer data and the second three-dimensional layer data to the radar-product training data; and
determine, to within a decision threshold, whether at least one of the first three-dimensional layer data or the second three-dimensional layer data represent a known product.

17. The radar system of claim 14, wherein the radar field-of-view comprises one or more of a power-on zone, a wake-up zone, a vision capture region, and a scan region.

18. The radar system of claim 17, wherein the radar system is further configured to:
detect a person within the power-on zone;
generate an activation signal configured to power-on a computing device; and
transmit the activation signal via a communications interface.

19. The radar system of claim 14, wherein the radar system is further configured to:
generate electromagnetic waves based on radar parameters; and
transmit the electromagnetic waves, wherein the electromagnetic waves define the radar field-of-view based, at least in part, on the radar parameters.

20. A computer-implemented method for using a radar system to identify an object, the computer-implemented method comprising:
capturing three-dimensional layer data from a radar field-of-view;
comparing, at least in part, the three-dimensional layer data to radar-product training data; and
determining, to within a decision threshold, whether the three-dimensional layer data represent a known product.
